(19) United States
(12) Patent Application Publication
(10) Pub. No.: US 2017/0355435 A1
(43) Pub. Date: Dec. 14, 2017

(54) WINGLESS AIRCRAFT

(71) Applicant: Francis Joseph Clark, Clearfield, PA (US)

(72) Inventor: Francis Joseph Clark, Clearfield, PA (US)

(21) Appl. No.: 14/999,667

(22) Filed: Jun. 10, 2016

(51) Int. Cl. B64C 1/16; B64C 9/00; B64C 25/04

(52) U.S. Cl. CPC B64C 1/16; B64C 25/04; B64C 9/00

(57) ABSTRACT

Wings do not produce lift. It is the thrust provided by an engine (or engines) that enable an aircraft to rise off the ground.

### CROSS REFERENCE TO RELATED PUBLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

Since the beginning of manned flight, engineers have assumed that wings were necessary to provide lift for an aircraft.

However, wing failures are a frequent cause of plane crashes.

Also, wings add considerable weight.

Finally, wings add unnecessary friction when the aircraft is in flight.

### BRIEF SUMMARY OF THE INVENTION

This type of aircraft differs from common airplane designs in that it has no wings, and that engine(s) and landing gear are appended to the fuselage.

### BRIEF DESCRIPTION OF THE SEVERAL VIEWS OF THE DRAWING

FIG. 1 shows the side view of a typical wingless aircraft design

FIG. 2 shows the top view of a typical wingless aircraft design.

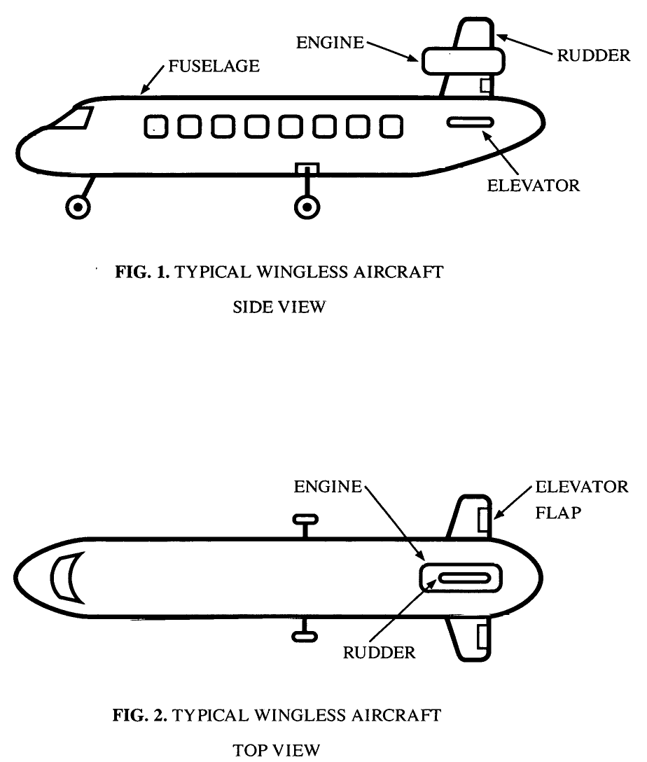

### DETAILED DESCRIPTION OF THE INVENTION

Wings are totally unnecessary for flight. It is the thrust provided by an engine that forces an aircraft off the ground and into the air.

When an aircraft is moving down the runway, it doesn't life off until the pilot pulls back on the wheel. This causes the elevator flap to tilt up. Air pressure on the elevator flap then forces the tail of the aircraft down. Consequently, the nose of the aircraft is pointed up and, if thrust produced by the engine is great enough, the aircraft will rise off the ground. After that, the aircraft rises or falls in accordance with the elevator flap position.

Without wings, air travel would be safer, cost of aircraft would be much lower and fuel consumption would be much lower.

1. This type of aircraft has an elongated fuselage, rudder, elevator and engine, but does not have wings.
